(19) United States
(12) Patent Application Publication
(10) Pub. No.: US 2024/0017707 A1
(43) Pub. Date: Jan. 18, 2024

(54) MODULAR BRAKING DEVICE

(71) Applicant: GETPLUS S.R.L., Padova (IT)

(72) Inventor: Tommaso GECCHELIN, Padova (IT)

(21) Appl. No.: 18/252,751

(22) PCT Filed: Aug. 24, 2021
(86) PCT No.: PCT/IB2021/057744

§ 371 Date: May 12, 2023

(30) Foreign Application Priority Data
Nov. 16, 2020 (IT) 102020000027342

(51) Int. Cl. B60T 11/04; B60D 1/64

(52) U.S. Cl. CPC B60T 11/04; B60D 1/64; B60Y 2200/40

(57) ABSTRACT

A modular braking device, suitable for being installed on a system of modular vehicles, the system including at least two vehicles detachably connectable to each other, wherein the vehicles when connected to form the system form a rigid train without relative rotations between the vehicles, wherein each of the vehicles includes a braking system which can be activated by control means accessible by a user, and including on each of the vehicles, connectors of the controls to a transmission bar of the braking control, the transmission bar extending for the length of the vehicles, and wherein the bars of the vehicles are connected when the vehicles are connected to form the system of modular vehicles.

The present invention relates to a modular braking device adapted to be installed on a modular vehicle system of the type specified in the preamble of the first claim. Systems are currently known which are suitable for transmitting a braking command to a train of vehicles connected to each other in an articulated manner, not rigidly, therefore with the possibility of relative rotations between the vehicles of the train. Pneumatic and/or inertial braking systems in vehicles towing trailers, or combinations of said systems, are in fact known.

They have connections which can be mechanical, pneumatic or similar.

The known art described includes some important drawbacks.

The pneumatic and/or inertial braking systems typical of vehicles pulling trailers, for example, are not suitable for said trains of vehicles rigidly connected to each other and moreover they do not give the possibility of coupling more than one trailer in succession.

In particular, pneumatic systems are very complex and expensive, and are not suitable for coupled vehicles with their own and independent braking system, such as for example two independent vehicles connected to form a modular vehicle system.

In this situation, the technical task underlying the present invention is to devise a modular braking device capable of substantially obviating at least part of the aforementioned drawbacks.

Within the scope of said technical task, it is an important object of the invention to obtain a device of the “plug and play” type which is operative for coupling two vehicles without the need for an operator.

Another important object of the invention is to provide a modular device, present on vehicles capable of being rigidly connected to each other in a modular vehicle system.

Again, an important object of the invention is to provide a completely mechanical device which does not involve delays in the transmission of the braking command between different vehicles.

In addition, an important object of the invention is to provide a highly safe device in the event of breakdowns in the servo-assisted braking systems of vehicles.

Finally, an important object of the invention is to provide a device which can connect a plurality of vehicle braking systems to transmit a command.

The technical task and the specified aims are achieved by a modular braking device adapted to be installed on a modular vehicle system as claimed in the annexed claim 1.

Preferred technical solutions are highlighted in the dependent claims.

The characteristics and advantages of the invention are clarified below by the detailed description of preferred embodiments of the invention, with reference to the accompanying figures, in which:

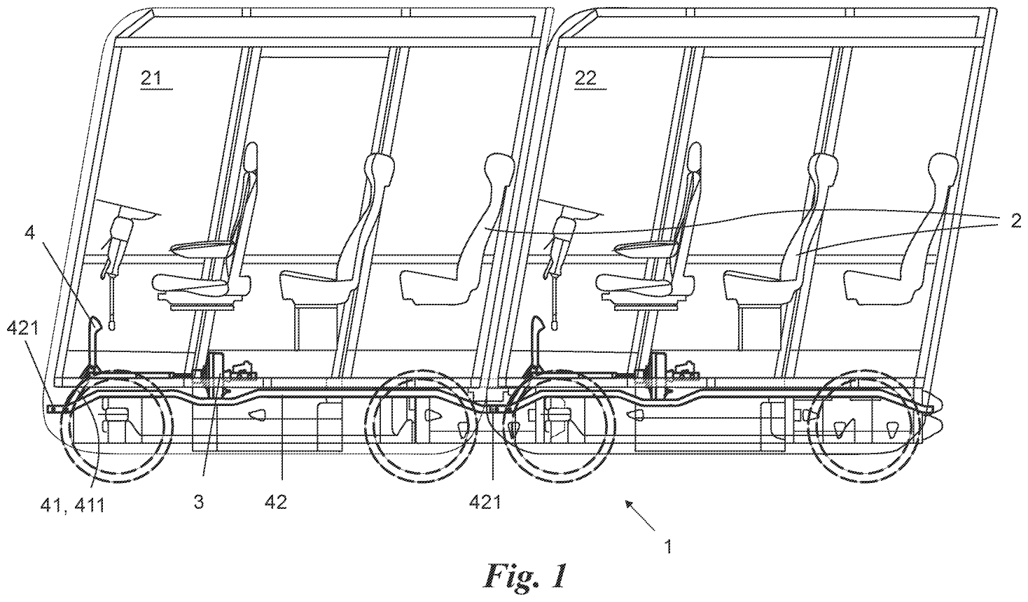

FIG. 1 shows a schematic illustration of modular braking device installed on two modules of a modular system vehicles.

In the present document, the measurements, values, shapes and geometric references (such as perpendicularity and parallelism), when associated with words like “about” or other similar terms such as “approximately” or “substantially”, are to be considered as except for measurement errors or inaccuracies due to production and/or manufacturing errors, and, above all, except for a slight divergence from the value, measurements, shape, or geometric reference with which it is associated. For instance, these terms, if associated with a value, preferably indicate a divergence of not more than 10% of the value.

Moreover, when used, terms such as “first”, “second”, “higher”, “lower”, “main” and “secondary” do not necessarily identify an order, a priority of relationship or a relative position, but can simply be used to clearly distinguish between their different components.

Unless otherwise specified, as results in the following discussions, terms such as “treatment”, “computing”, “determination”, “calculation”, or similar, refer to the action and/or processes of a computer or similar electronic calculation device that manipulates and/or transforms data represented as physical, such as electronic quantities of registers of a computer system and/or memories in, other data similarly represented as physical quantities within computer systems, registers or other storage, transmission or information displaying devices.

The measurements and data reported in this text are to be considered, unless otherwise indicated, as performed in the International Standard Atmosphere ICAO (ISO 2533:1975).

With reference to the figures, the modular braking device according to the invention is globally indicated with the number 1.

Preferably, the modular braking device 1 is adapted to be installed on a modular vehicle system 2.

Said modular vehicle system 2 comprising at least two vehicles 21, 22, as shown in the exemplary embodiment of FIG. 1.

As will become clear in the following, the device 1 is suitable for being installed on a system 2 of modular vehicles comprising a plurality of vehicles, being in fact a modular device 1 present identical on each vehicle suitable for composing the system 2.

Said vehicles 21, 22, are removably connectable to each other, and when connected they form a rigid train without relative rotations between said vehicles 21, 22. Said vehicles 21, 22 therefore form a rigid train without relative rotations in a horizontal plane, in a plane lateral and in a vertical plane. The structural connection between said vehicles 21, 22 can be carried out according to any system that allows the formation of a rigid train. The connection to form said rigid train must also be understood as a non-articulated connection between said vehicles 21 and 22 to form said system 2, as described above.

Preferably, each of said vehicles 21, 22 comprises a braking system 3 which can be activated by control means 4 accessible by a user. They can be manual, assisted, remote or automatic or more. The braking system 3 can for example be any braking system of the known art. Preferably the braking system 3 is a hydraulic system servo-assisted by a pneumatic vacuum servo.

Said controls 4 can consist of a pedal or any other element capable of transmitting a braking command by moving at least part of the components of the controls 4. Said controls 4 can be actuated by a physical user or by an automatic system, for example a remote control and/or guidance system. Again, preferably, said controls 4 accessible by a user comprise at least the control of the service brake of the vehicles 21, 22.

Preferably, the device 1 according to the present invention comprises, on each of said vehicles 21, 22, connection means 41 for said commands 4 to a transmission bar 42 of the braking command. By connection means 41 in the present document it is meant a system, preferably mechanical, able to transmit the movement caused by a braking command.

In the embodiment shown in FIG. 1 said connection means 41 comprise mechanical leverages 411.

Preferably, according to the present invention, the transmission bar 42 extends for the length of the vehicles 21, 22.

Again, preferably, the bars 42 of the vehicles 21, 22 are connected when said vehicles 21, 22 are connected to form said system 2 of modular vehicles. The connection or contact of the bars 42 therefore allows the transmission of a braking command from one vehicle 21 to the other vehicle 22, or vice versa, by means of its mechanical movement at least in a single direction, or rather by pushing at least in the direction that allows the transmission of a braking command from a leading vehicle to a trailing vehicle or vice versa, since generally each braking system 3 of the prior art has a return-to-position system, which returns the system 3 to the non-braking position and the bars 42 thereto and connected to each other. The rigid assembly formed by the connection of said bars 42 allows the actuation of the braking systems 3 of each vehicle of the modular vehicle system 2, through the movement of connection means 41, controls 4 and finally of the actuator of the braking system 3.

Still, preferably according to the present invention the distal ends of said transmission rods 42 are provided with joining means 421 comprising magnetic couplings, mechanical, pneumatic and/or electronic acts to bind together the said transmission bars 42 and in particular of a braking command. Finally, preferably in an alternative embodiment, or in combination with what has been described, said braking system 3, said connecting means 41 and said transmission bar 42 of the braking control are servo-assisted systems.

The operation of the device 1 previously described in structural terms is as follows.

In its simplest embodiment, shown in FIG. 1 The service brake pedal 4 is connected to a lever 41 which pushes in parallel both the cylinder, or any other actuation system, of the braking system 3 of the vehicle wherein it is, either, in parallel a bar 42 which reaches the rear of the vehicle and up to the front end of the same. From the moment of rigid coupling of another vehicle, the rear part of the bar 42 of the leading vehicle comes into contact with the front part of the bar 42 of the tailing vehicle, which in turn pushes on the cylinder of the brake system 3 of the rear vehicle. In this way a bar 42 puts the braking systems 3 of all the connected vehicles in series to form the modular system 2. Therefore, if the driver or equivalent remote or driverless driving system in the lead vehicle presses the brake pedal, the brake cylinder of the vehicles connected in the rear are also pressed, in a completely mechanical way.

The device 1 according to the invention achieves important advantages.

In fact, advantageously this solution does not need complex connection systems, such as for example inertial or electro-pneumatic systems, between one vehicle and another so that the construction and maintenance cost is much cheaper than existing solutions.

Furthermore, a modular braking device 1 fully automatically engages a further modular braking device 1 of another vehicle when the vehicles are rigidly coupled, since the bar 42 comes into contact with that of the rear vehicle.

In addition, advantageously with respect to the systems of the known art, there are no delays in the transmission of the braking command since the mechanical bar 42 is rigid and incompressible, unlike, for example, the braking systems of trailers based on a pneumatic circuit.

A further advantage of the device 1 according to the present invention is that, in the event of failure of the servo assistance on one of the connected means, the modular vehicle system 2 remains safely braked and with relatively little force applied to the pedal or to the controls 4 since the force resulting on bar 42 will always be the sum of the contributions of the brake servo-assistance systems of all the connected units. Finally, at a regulatory and certification level, this system is neither configured as a “brake-by-wire” nor as a braking device for trailers, since each vehicle is rigidly coupled and potentially constitutes an independent unit equipped with traction, steering, braking and own energy source. The resulting vehicle, called modular vehicle system 2, is configured as a single, longer vehicle, not as a combination of tractor and trailer. This aspect makes the system eligible under the ECE13 braking system standard, for one vehicle as type M1/N1 and for two or more vehicles as M2/M3/N2.

The invention is susceptible of variants falling within the scope of the inventive concept defined by the claims.

In this context, all the details can be replaced by equivalent elements and the materials, shapes and dimensions can be any.

1. A modular braking device capable of being installed on a system of modular vehicles, said system comprising
at least two vehicles removably connectable to each other, wherein said vehicles when connected to form said system they form a rigid train without relative rotations between said vehicles, in which each of said vehicles comprises at least one braking system which can be activated for control means accessible by a user, and
comprising, on each of said vehicles, means for connecting said controls to a transmission bar of the braking control, said transmission bar extending for the length of the vehicles, and wherein said bars of the vehicles are connected when said vehicles are connected to form said system of modular vehicles.

2. The device according to claim 1, wherein said connection means comprise levers mechanics.

3. The device according to claim 1, wherein said controls accessible by a user comprise at least the service brake control of the vehicles.

4. The device according claim 1, wherein said braking system, said connection means and said transmission bar of the brake control are servo-assisted systems.

5. The device according to claim 1, wherein the distal ends of said transmission bars are provided with joint means comprising magnetic, mechanical, pneumatic and/or electronic joints suitable for binding between them called transmission bars.

6. The device according to claim 2, wherein said controls accessible by a user comprise at least the service brake control of the vehicles.

7. The device according to claim 6, wherein said braking system, said connection means and said transmission bar of the brake control are servo-assisted systems.

8. The device according to claim 7, wherein the distal ends of said transmission bars are provided with joint means comprising magnetic, mechanical, pneumatic and/or electronic joints suitable for binding between them called transmission bars.
